(19) United States
(12) Patent Application Publication
(10) Pub. No.: US 2013/0345843 A1
(43) Pub. Date: Dec. 26, 2013

(54) IDENTIFYING AUDIO STREAM CONTENT

(71) Applicants: Liam Young, Dublin (IE); Morris Stephen, Dublin (IE)

(72) Inventors: Liam Young, Dublin (IE); Morris Stephen, Dublin (IE)

(21) Appl. No.: 13/892,046

(22) Filed: May 10, 2013

Related U.S. Application Data
(60) Provisional application No. 61/645,474, filed on May 10, 2012.

(51) Int. Cl. G06F 17/30

(52) U.S. Cl. CPC G06F 17/3074
USPC 700/94

(57) ABSTRACT

The method and apparatus of the invention relate to identifying a streaming audio signal. The method and apparatus store a plurality of reference audio signals, and receive an audio signal to be identified. A segment of the received audio signal is selected and converted into the frequency domain. It is then sequentially compared to a converted segment, of corresponding length, of a reference signal or signals stored in data storage. This is performed in the frequency domain. The comparison correlates frequency power peaks at each frequency of interest in the received and corresponding reference signal frequency domain representations, and recognizes the received signal as the reference signal when the number of comparisons is properly compared with regard to a threshold value.

### CROSS REFERENCE TO RELATED APPLICATION

This application claims the benefit of U.S. Provisional Patent Application No. 61/645,474, filed May 10, 2012, which is hereby incorporated by reference herein in its entirety.

### BACKGROUND

The invention relates to identifying audio in a content stream, and more particularly to a method and apparatus for identifying audio content in substantially real time.

Broadcast and internet radio and television stations broadcast media streams typically containing a combination of audio types: speech (DJs, advertisers, etc.) and music (artists, advertising jingles, etc.). Both content types are not necessarily exclusive, that is, many DJs introduce a song during the beginning of the track. In either case, identification and reporting on the stream content is a difficult problem.

### SUMMARY

The apparatus and method of the invention is directed to the use of reference material (such as, CD tracks) to identify an associated stream content. Sonic potential applications are:
1. The need for airplay reporting, for example, for collection agencies
2. Offering artists a reporting service accounting for airplay of their material
3. A royalty reconciliation facility for collection agencies and artists
4. Other areas—media audits, voice recognition, determining if music has been sampled, etc.
5. Identification of Intellectual Property held on a remote server using the Internet, for example, using web crawling methodologies

The identification capability takes the form of a set of facilities to identify streamed content with respect to a defined set of reference material. Following successful identification, the following data may be recorded: track name, album, track mix, artist, producer, radio station, date of playout, and time of playout.

The apparatus and method use a set of references that define the music that is to be identified. In other words, the search problem reduces to a known set of reference audio tracks. Further, the apparatus and method operate outside a radio station boundary, that is, there is no separate metadata feed or other playout list emanating from the radio station. The identification method operates in isolation from the radio station workflows and audio delivery systems.

Further, the method and apparatus operate an entrance point of the so-called “analog hole” which is the stage in the audio delivery pipeline just before the audio stream is decoded for playback on a set of analog speakers. In other words, the methodology can be said to be ‘all digital’.

In summary, there exists a significant gap in space and time between when a given item of audio is streamed and any subsequent owner attribution. There are many companies which work inside this gap, and the content owners are typically powerless to influence the attribution process. The method and apparatus of the invention can be used as a tool to enable the content owner to receive an equitable royalty payment. While the method and apparatus of the invention are especially useful with the Internet radio space, there are also other uses of the methodology of the invention outside the Internet radio space.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 illustrates the different power levels of an incoming stream with regard to its CD reference in accordance with some embodiments of the disclosed subject matter;

FIG. 2 diagrams portions of an identified audio track in WAV format in accordance with some embodiments of the disclosed subject matter;

FIG. 3 represents an audio characterization showing multiple samples in accordance with some embodiments of the disclosed subject matter;

FIG. 4 is a flow diagram for an audio identification method in accordance with some embodiments of the disclosed subject matter;

FIG. 5 is a flow diagram for a method of identifying an Internet audio track in accordance with some embodiments of the disclosed subject matter;

FIG. 6 represents audio tracks using the program Audacity in accordance with some embodiments of the disclosed subject matter;

FIG. 7 represents the frequency spectrum analysis of a sample of audio in accordance with some embodiments of the disclosed subject matter;

FIG. 8 is a comparison and result illustrating a positive identification resulting from the correlation of an input stream to a reference stream in accordance with some embodiments of the disclosed subject matter; and

FIG. 9 represents a failed or negative identification resulting from the correlation between an input stream and a reference track in accordance with some embodiments of the disclosed subject matter.

### DETAILED DESCRIPTION

The method and apparatus of the invention can be applied to audio identification in a number of different ways, such as comparing streamed audio tracks with CD reference tracks and/or comparing the streamed audio tracks with tracks from the same radio station.

The method is flexible in that it only requires an audio stream. It does not matter whether the stream comes from a CD or an Internet radio station feed.

Issues of identification.

One issue concerning identification of an audio stream is that of the volume/power settings used by Internet radio stations. This is closely related to the allied topic of a station-specific track mix. This issue occurs because the volume settings can vary widely between different radio stations. An example of this is Capital FM London and 2FM Dublin. Tracks recorded from Capital FM can sometimes be successfully identified from the associated CD track. The same is not true of 2FM Dublin because when the corresponding representative waveforms from the 2FM Dublin source are compared with a reference track, a straight comparison fails.

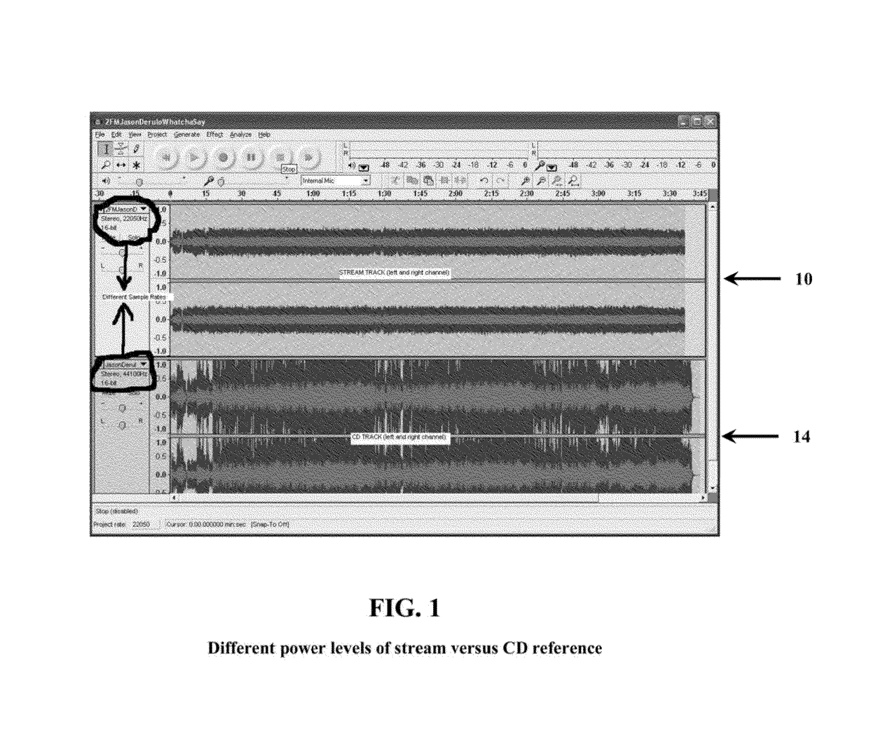

Referring to FIG. 1, the problem of power level difference is illustrated. The stereo track 10 at the top of FIG. 1 is recorded from 2FM while the stereo track 14 at the bottom of FIG. 1 is the CD copy of the same track (the song is Jason Derulo's “Whatcha Say”).

While FIG. 1 looks very complicated, it can be broken up into simpler pieces. Notice, for example in FIG. 1, the variations in the CD track 14 (at the bottom). The stream track 10 (at the top) displays much a lower power level and also less spectral diversity (up and down swings). The combination of these factors tends to reduce the chances of identification to close to zero. In this context, the stream and CD tracks are like two different songs.

A further problem with Internet streams is that many of them broadcast in monaural rather than stereo. Also their sample rates may be different. Often the stations may use a sample rate that differs from 44,100 samples per second, the standard rate for CD.

### The Method of the Invention

The identification methodology of a particular embodiment of the invention facilitates wider reporting options, that is, music and non-music applications. Non-music identification also appears to allow for verification of non-music content broadcast, for use, for example, by advertising agencies, etc.

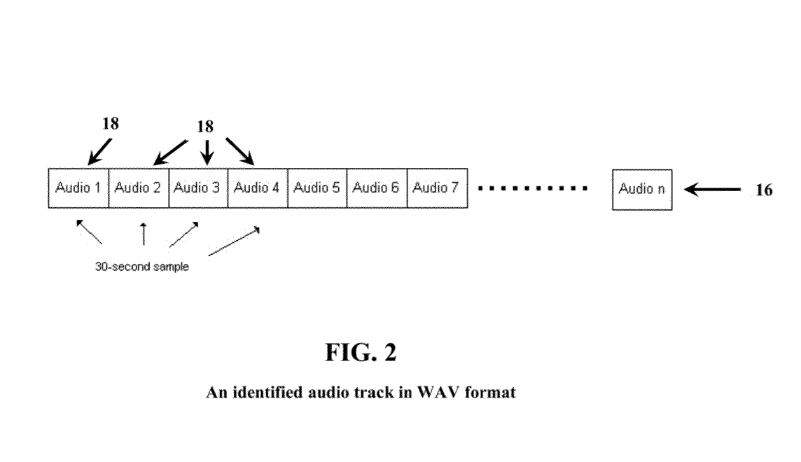

Referring to FIG. 2, an audio sample represents a complete and already identified track 16. In the discussion that follows, it is assumed that this track is already identified in a system database. In other words, the track in FIG. 2 is called a reference track. In addition, it is assumed that the reference track has been converted to a WAV format by some software facility, for example, Exact Audio Copy. Alternatively, the track may have been acquired by recording it from a target radio station stream. The identification method of the system can work in either case. The purpose of the following audio characterization method is to identify an incoming stream version of this track in the future.

Notice that the identified track in FIG. 2 is divided in this embodiment into 30-second segments 18. In other embodiments different sample durations can be used. This segmentation is a key to the identification mechanism and method.

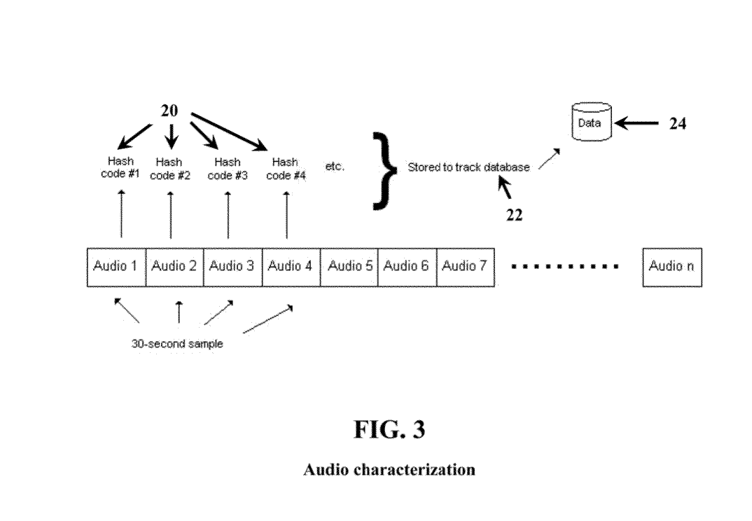

The first step after recording, the reference audio in FIG. 2 is to characterize the data samples using hash codes. The hashing mechanism simply takes each of the 30-second samples 18 in FIG. 2 and calculates and then stores at 22 a unique hash code 20 as illustrated in FIG. 3.

The hash codes in FIG. 3 are the peak amplitude values of the sample in the frequency domain. This method can be extended if required, for example, to include phase angle or other audio attributes. In fact, this extension may become mandatory as the method is used on an ever-larger audio data set.

Once all of the 30-second samples 18 have been hashed and stored at 22 in a data storage 24, the audio track can be said to be fully characterized using the track details (name, artist) and a full set of hash codes. This data can then be used to identify an incoming unknown track request.

Using MPlayer, an incoming stream audio is acquired by, in this embodiment, connecting to the Internet radio station stream, recording the stream contents as a WAV file, processing the stream WAV file in 30 second chunks, and looking for its reference tracks if this is a reference stream that is being created.

Now that reference tracks are known and characterized, a given Internet radio station track can be compared to the stored reference tracks, and identified with one of the references.

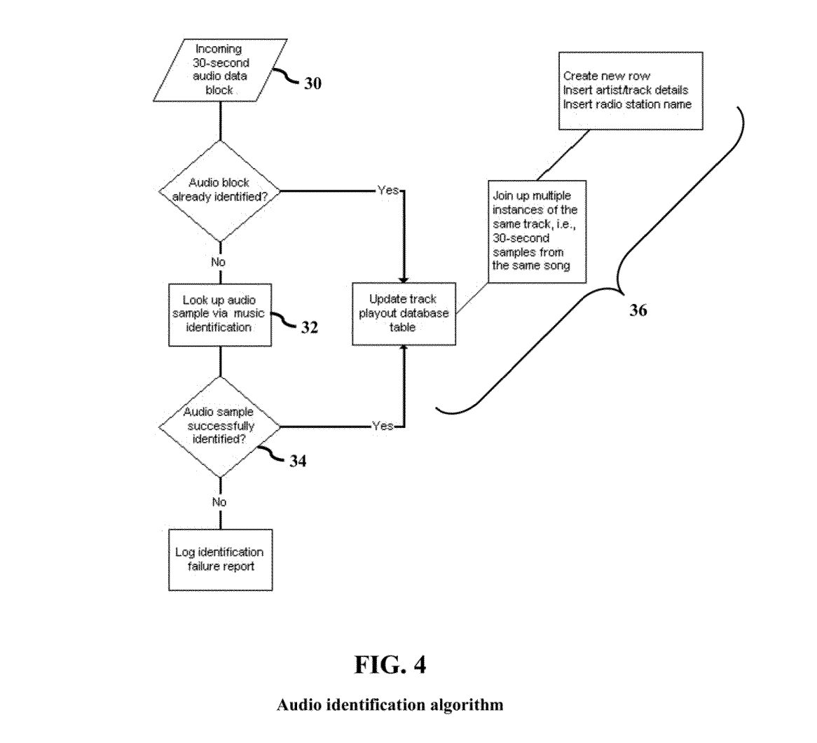

The track to be identified takes the form of an audio sample from an online radio station stream. Referring to FIG. 4, the first step 30 in the identification process is to extract the first 30 seconds from the incoming audio sample. The hash code value for this block of 30 seconds of audio is then calculated. Next, the calculated hash codes from the sample are compared at 32 against the track database to see if a match can be found against any of the characterized tracks. If a match is found at 34, then the stream track identified. FIG. 4 illustrates the lookup and hashing mechanism.

Referring to FIG. 4, the reference track database can be created (36) by initially recording tracks and then calculating their respective hash codes. This can be implemented using, a selected set of reference CD tracks. Thereafter, the required radio station(s) are monitored. Together these functional elements describe the identification service.

### Detailed Description of the Identification Methodology

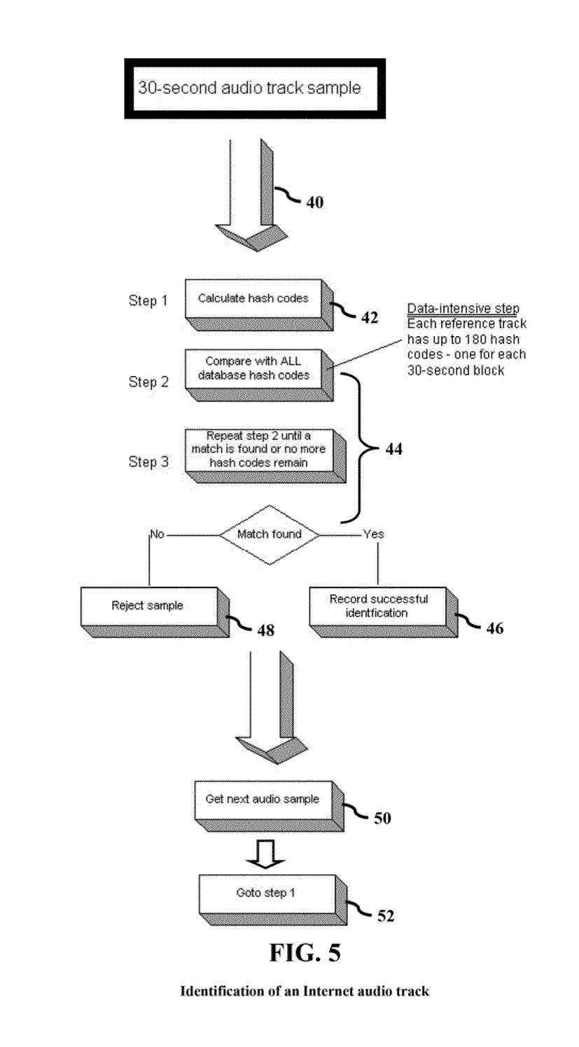

The easiest way to describe the method in detail is to consider an actual example. Consider, then, a stream WAV recording from which we want to identify all of the constituent reference tracks. This is illustrated in FIG. 5. A first 30-second extract is presented for identification at 40.

The first step 42 is to calculate the hash codes for the first 30-second audio block of the incoming track. Next, the entire database of hash codes is searched at 44 for a match. Note that this comparison step is potentially very data-intensive; for example, if there are 1000 reference tracks then the system might have to perform up to 180,000 comparisons, that is, 180 hash codes for each track comparison.

If the 30-second audio sample is successfully identified, that is, passes the required “test” as described in more detail below, then the search is successful at 46. If all hash codes in the database have been searched without success, then a failed search result is returned at 48. If the search fails, the search window is incremented in time (1 second in the illustrated exemplary embodiment) and the 30-seconds of audio in the incremented search window are selected at 50 and the search process starts over at 52.

In a particular embodiment of the invention, the audio identification method and apparatus, perform as follow. First, the method determines a cross-spectrum hash code for 30 seconds of the incoming radio stream and for 30 seconds of a reference track. Then, the magnitude spectrum peaks of the radio stream and the reference track are determined. The system then compares the cross-spectrum hash codes and the magnitude spectrum peaks of the stream and the reference tracks as described, for example, below. If no match is found, the system moves 1 second along the radio stream and starts over again until either a match is detected, or there are no additional (30 second) tracks to be compared.

Whenever a positive match is found, is successful match is declared, it being assumed that the next 30 seconds of the same track will also match.

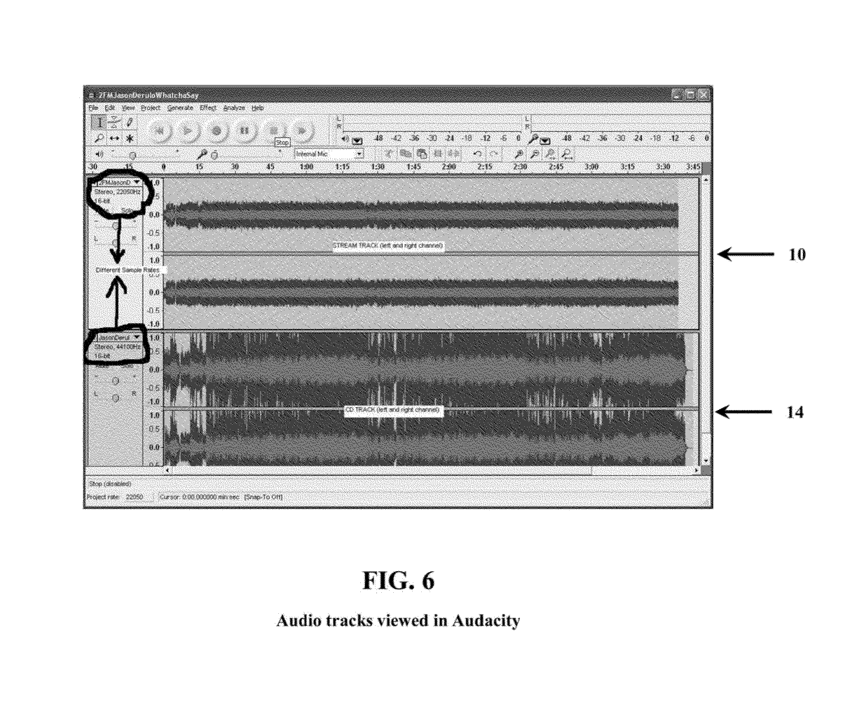

FIG. 6 illustrates the two example audio segments that were illustrated in FIG. 1. In FIG. 6 the two audio tracks are both illustrated in stereo. The track 10 at the top of FIG. 6 is an excerpt from an Internet radio stream and the track 14 at the bottom is the corresponding CD reference.

Breaking FIG. 6 down into its component parts, it can be seen that each channel is nothing more than a stream of numbers or instantaneous sound samples. The (time domain) data in FIG. 6 are unwieldy from an analytical point of view. Each digital sample is basically a measure of loudness in the time domain and comparison of time domain values between the incoming stream and the CD tracks tends to yield little because the variation is simply too great to enable the system to identify any major underlying similarities. In short, any identification methodology based on time domain samples tends to be “brittle.”

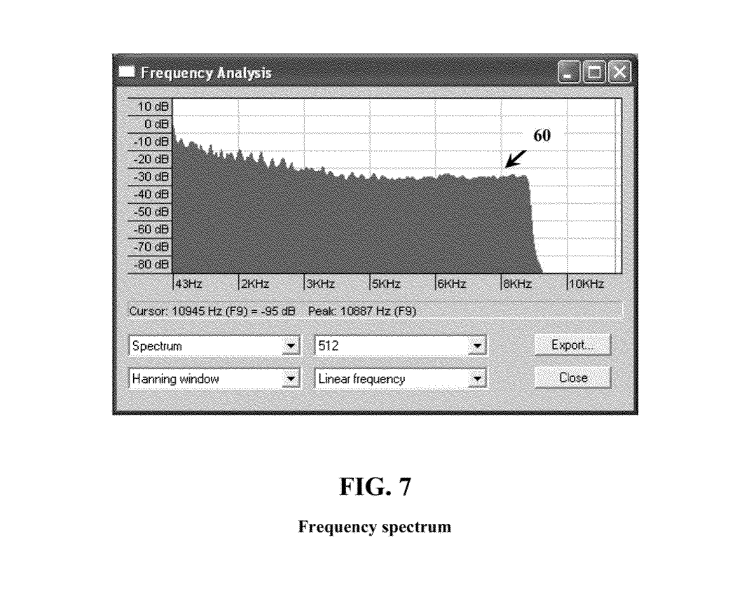

Fortunately, in accordance with the invention, the system converts the time domain data to the frequency domain by passing the time domain data through a Fast Fourier Transform (FFT) or a Discrete Fourier Transform (DFT) function. The result is a new sequence 60 of numbers where each point represents an analysis frequency as illustrated in FIG. 7. While the description below uses a FFT to convert from the amplitude to the frequency domain, another optimization advantage may be obtained using the DFT instead as is well known in the field.

Referring to FIG. 7, an analysis frequency can be thought of as being an “atom” of the overall audio track. The complete track is the aggregate of the “atoms” or analysis frequencies. Each analysis frequency resulting from the Fourier Transform is represented as a complex number, that is, a number in the form A+jB, where A is the real part and B is the imaginary part.

As a result, the audio representation moves from a time domain track (as in FIG. 6) to a frequency spectrum as illustrated in FIG. 7. Each element in FIG. 7 represents, for a “chunk” of streaming audio, (a 30-second “chunk” in the illustrated embodiment) the signal amplitude at each specific frequency in a range of frequencies.

An important point to note about the FFT is that it is reversible, that is, we can convert from the data of FIG. 7 back to the data of FIG. 6 with no loss of data. In other words, the FFT simply provides another representation of the audio data. However, the FFT output is a powerful analysis tool precisely because the original time domain data has been separated into its constituent frequency components. This means that we can now look at the data in a range of different ways.

The human ear can typically hear sound roughly in the frequency range from 15-20 Hz to about 20 kHz. This is a wider range than that illustrated in FIG. 7. In other words, not all music tracks will use the full range of frequencies. Indeed, the true power of the FFT is revealed in the way it allows for the signal frequency spectrum to be divided into a range of analysis frequencies.

Assume that we have a time domain audio track with ‘N’ samples. The value of N is calculated based on a few parameters for the track. For example, a monaural track is typically sampled at 44,100 samples per second. Further, assume we have 30 seconds of this signal. We then have

$$\begin{matrix}N = 30 [ seconds ] * 44100 [ samples ] / [ second ] \\ = 1 , 323 , 000 [ samples ]\end{matrix}$$

So, for 30 seconds of a monaural track, there are a total of 1,323,000 samples.

Each of the analysis frequencies. F(m), in the FFT is related to the value of N as follows:

F(m)=m*F(sample rate)/N

where m starts at zero and increases up to N (1,323,000). If we vary the value of “m,” F(m) changes. For the chosen value of N equal to 1,323,000 samples, and a sampling frequency of 44,100,

$$\begin{matrix}F ( 0 ) = 0 * 44100 / 1 , 323 , 000 \\ = 0\end{matrix}$$

$$\begin{matrix}F ( 1 ) = 1 * 44100 / 1 , 323 , 00 \\ = 0.0333333\end{matrix}$$

Thus, the audio signal has its first possible FFT analysis frequency at 0.033333 Hz and the calculated FFT will indicate if the audio signal actually has a component at this analysis frequency.

$$\begin{matrix}F ( 2 ) = 2 * 44100 / 1 , 323 , 000 \\ = 0.066666\end{matrix}$$

The audio signal has its second analysis frequency at 0.066666 Hz and as before, the FFT will indicate if the audio signal actually has a component at this analysis frequency.

From the above, it can be seen that the sample rate is inextricably interwoven with the analysis of the audio signals. This is why the sample rate is one of the key parameters included in a WAV file header. The sample rate is included in WAV file headers for ‘downstream’ DSP work. Note that our use of DSP is really more accurately described as digital signal analysis. This is because the DSP tends to feed the processed signals back into the ‘system’, whereas our use of the DSP techniques terminates in our use of the incoming audio signals.

Once the number of samples to use is decided, the next stage is to extract the associated audio samples from the WAV files. There is one WAV file for the stream recording and a second WAV file for each reference track.

The audio data is extracted from disk and stored in signal structures. These are simply containers for the audio data. The EFT code runs using the signal structures and operates in-place In other words, the FFT result overwrites the signal structure. The use of an in-place operation is simply a programming convenience and avoids the need to allocate memory for both the original audio data and the FFT output. The result of the FFT is a new set of numbers. However, as noted above, the FFT numbers are complex.

Each of the analysis frequency elements in the frequency spectrum contributes to the magnitude spectrum of the audio track. The magnitude spectrum is made up of the sum of the square root of the squares of the real and complex parts of each FFT complex value. Accordingly, the following computation is preferred for each analysis frequency:

Magnitude=SORT(A*A+B*B)

Again, this generates another long list of numbers for both the input stream and the reference tracks. Next, the tracks are compared as follows. When both the input stream track and the reference track are transformed into the frequency domain and we then have determined the magnitude spectrum for each, the system makes the comparisons, in effect, the whole identification problem reduces to comparing two very long sequences of magnitude spectrum numbers. Clearly, the identification and hence the comparison must be repeated many times as the system moves through each reference track looking, for a match.

Accordingly, in this exemplary embodiment, the methodology described above represents one of the major merits of the exemplary matching process; that is, the continuous identification of an incoming audio stream where a block of 30 seconds is isolated, converted, and then identified against the reference set.

While computational efficiency has not been one of the principal requirements in this phase of the analysis, it is important that the identification method be as fast as possible. With this in mind, the method can be simplified and optimized if required to meet more stringent real time requirements.

One simple optimization change is to pre-calculate the FFT values for the reference tracks. These pre-calculated values can be stored in a database and looked up during processing of Internet radio stream audio samples.

Another improvement is to skip ahead once an incoming radio stream sample has been identified. This avoids re-identifying the same track. However, skipping ahead does run the risk of skipping past a new track so it would need to be employed with caution.

The recognition signature for a portion of a track is formed by dividing frequency position values for the stream and for the reference (for example CD) signals and then comparing the result, individually for each of a plurality of frequency segments, against an expected threshold value. More specifically, the magnitude spectra for both the stream and CD signals are divided into a number of discrete frequency segments or regions. In one exemplary embodiment, the regions are 250 Hertz wide, and the total spectrum being compared is 10 Kilohertz (or forty regions). The frequency positions of the peaks in each discrete region are noted, for example as a frequency offset from the beginning of the region in which the peak appears. The peak offset values for the unknown and reference signals are stored, for example, in two data structures. The offset frequency values for the corresponding peaks are then divided into each other to determine if there is a match, that is, whether the respective frequency offset values of the identified peaks are within a specified distance of each other.

In one particular embodiment, just one threshold value is employed for the comparison. The selected value in this version of the code is “19”, and “19” means that if 19 shared peaks are detected in the magnitude spectra for both the stream and reference tracks, then we have a match.

More particularly, in the preferred exemplary embodiment, the peaks selected to correspond are the last detected peak of each of the respective regions. In this embodiment, the amplitude values of the peaks are ignored and not used. A comparison is found in a region if the result of dividing the frequency offset position of the reference peak by the frequency offset position of the unknown input signal is in the range 0.98-1.04. In a particular embodiment, to declare a match to the entire input media (song, etc.), the system and method of the exemplary embodiment requires thirty-seven 30 second segments to be matched, and requires 70% or more matching segments in a 3 minute period to declare a successful identification.

The identification method thus makes use of comparative analyses of the FFT magnitude spectra for the stream and reference tracks. In this context, the use of the FFT magnitude spectra can be considered, in DSP parlance, as a ‘reference vector’.

In the illustrated embodiment, the method and apparatus of the invention can perform an embedded test. This is a test where two tracks are combined in an incoming radio stream, that is, track 1 finishes and then track 2 starts. The identification code must then correctly differentiate between the two tracks. Embedded tests have been run in a fairly ad hoc manner, and the results have been positive. This is important for those cases where a given stream recording contains more than one reference track. The method of this embodiment of the invention examines any and all tracks in a recording and produces identification hits where matches are found. If matching or shared peaks occur, then this is recorded as a match. This peak determination can occur if one or more tracks occur in a given recorded segment.

### EXAMPLE 1

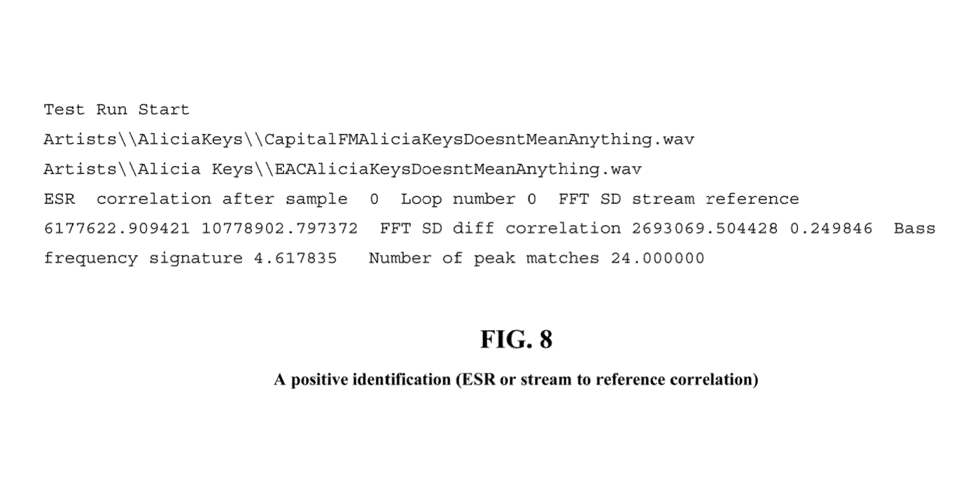

Referring to FIG. 8, the last number at the bottom of the figure (24.000000) represents the number of shared peaks. Given that a threshold of 19 is assumed, this is taken as a positive identification that a match is found. The message at the bottom of FIG. 8 is an alert or informational message that is sent to an identification server. Once the alert is received, the server updates a file indicating the identification event.

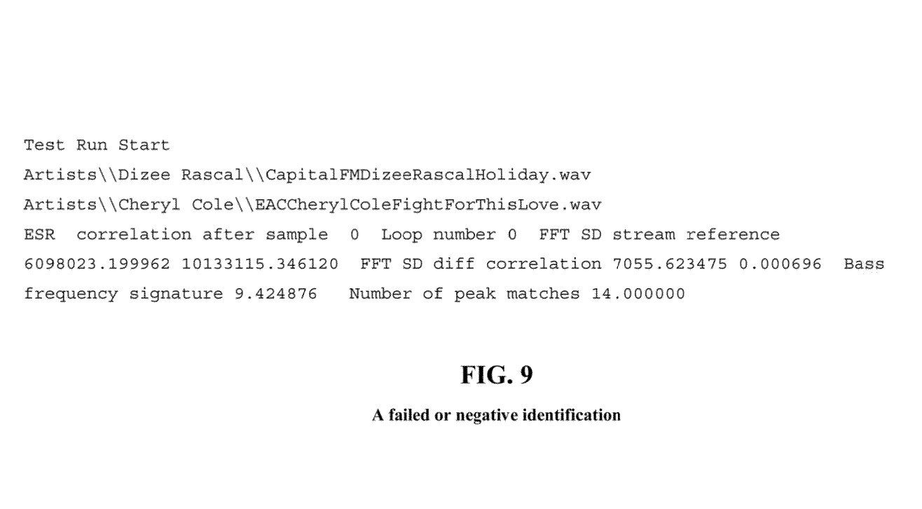

Referring to FIG. 9, an example of a negative identification, that is a failed identification, is described. Notice in FIG. 9 that the number (14.000000) of peaks is outside the required range (that is, less than or equal to 19), so we judge this as a negative identification.

### EXAMPLE 2

A group of 100 tracks was recorded from Internet radio streams using an open source VLC media player. The corresponding CD references were sourced and converted to an equivalent set of 100 WAV files using the package Exact Audio Copy (EAC).

Two types of tests were executed: positive and negative. A positive test occurs where a recording of an Internet radio stream is compared against the corresponding CD reference track. The expected result from a positive test is a positive one, that is, a true positive. A failed positive test is a false negative.

A negative test occurs where a recording of an Internet radio stream is compared against a non-corresponding (that is, not the same) CD reference track. The expected result from a negative test is a negative one, that is, a true negative. A failed negative test is a false positive.

Comparing all 100 streams against the equivalent CD references yielded a correct positive result 81% of the time.

Negative tests are organized by simply comparing, dissimilar tracks, that is, comparing, for example, track 1 against reference tracks 2 to 15. A small number, 2%, of such negative test runs produced false positives.

Computational efficiency was hinted at above, and is an important part of a performance upgrade by automating the audio acquisition process. A first step in this direction as noted above, is pre-calculating the reference track hash codes and storing them in a database. Then, each time an incoming stream sample is hashed, the comparison with the reference values is simply a database lookup.

Some potential applications of the audio identification method and apparatus include accurate real time royalty calculation, media audits, an adjunct to iTunes® for track identification, and voiceprint analysis.

Accurate real time royalty calculation for royalty collection would most likely be a service-style deployment of the audio identification technology. This type of application is likely to follow a subscription model where users can run reports that detail airplay for selected tracks.

Media audits are quite similar to the royalty collection scenario. This application also works after the fact, that is, a comparison is done to determine if a given item of reference advertising has been broadcast. Tests were run and show that the identification code is capable of spoken voice detection.

Using the audio identification technology in an iTunes® scenario would allow users to employ more powerful technology than the existing iTunes® tagging tools.

Voiceprint analysis is already used in US law enforcement. A typical use requires alleged defendants to furnish a number of reference recordings. The latter are then compared against telephone intercepts or remote field microphone recordings. A similar use of the audio identification technology is in voice-activated laptop security.

Other objects and features of the invention will be apparent to those practiced in this field, and are within the scope of the following claims.

Although the invention has been described and illustrated m the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A method for identifying a streaming audio signal comprising:
storing a plurality of reference audio signals;
receiving an audio signal to be identified;
selecting a segment of the received audio signal and converting it into the frequency domain;
sequentially comparing the converted segment against corresponding length segments of the reference signals in the frequency domain, said sequentially comparing comprising correlating frequency power peaks at each frequency of interest in the received signal frequency domain representation and a corresponding reference signal frequency domain representation; and
recognizing the received signal as the reference signal when the number of comparisons are properly compared to a threshold number.

2. The method of claim 1, further comprising storing said plurality of reference signals in respective frequency domain representations as a data structure.

3. The method of claim 2, further comprising incrementing, in response to a failure of recognition, the time domain segment of the received signal, by specified time increment, and repeating the sequentially comparing and recognizing steps.

4. The method of claim 1, wherein said comparing step further comprises determining frequency positions of peak values in each of a plurality of segments of the frequency spectrum of the stored received and reference signals, and using the results of that determination in determining the a relative comparison between the incoming and reference segments in the frequency domain.

5. The method of claim 4, further comprising storing said frequency positions relative to the beginning of the segment in which the frequency peak appears.

6. The method of claim 5, further comprising selecting only the last frequency peak of a segment for storage.

7. The method of claim 1, further wherein the comparison of the segments uses at least one of a positive test, a negative test, and an embedded test.

8. A system for identifying a streaming audio signal comprising:
a hardware processor that is configured to:
store a plurality of reference audio signals;
receive an audio signal to be identified;
select a segment of the received audio signal and converting it into the frequency domain;
sequentially compare the converted segment against corresponding length segments of the reference signals in the frequency domain, said sequentially comparing comprising correlating frequency power peaks at each frequency of interest in the received signal frequency domain representation and a corresponding reference signal frequency domain representation; and
recognize the received signal as the reference signal when the number of comparisons are properly compared to a threshold number.

9. The system of claim 8, wherein the processor is further configured to store said plurality of reference signals in respective frequency domain representations as a data structure.

10. The system of claim 9, wherein the processor is further configured to increment, in response to a failure of recognition, the time domain segment of the received, signal, by specified time increment, and repeat the sequentially comparing and recognizing steps.

11. The system of claim 8, wherein the processor is further configured to determine frequency positions of peak values in each of a plurality of segments of the frequency spectrum of the stored received and reference signals, and use the results of that determination in determining the a relative comparison between the incoming and reference segments in the frequency domain.

12. The system of claim 11, wherein the processor is further configured to store said frequency positions relative to the beginning of the segment in which the frequency peak appears.

13. The system of claim 12, wherein the processor is further configured to select only the last frequency peak of a segment for storage.

14. The system of claim 8, wherein the comparison of the segments uses at least one of a positive test, a negative test, and an embedded test.

15. A computer-readable medium containing computer-executable instructions that, when executed by a processor, cause the processor to perform a method for identifying a streaming audio signal, the method comprising:
storing a plurality of reference audio signals;
receiving an audio signal to be identified;
selecting a segment of the received audio signal and converting it into the frequency domain;
sequentially comparing the converted segment against corresponding length segments of the reference signals in the frequency domain, said sequentially comparing comprising correlating frequency power peaks at each frequency of interest in the received signal frequency domain representation and a corresponding reference signal frequency domain representation; and
recognizing the received signal as the reference signal when the number of comparisons are properly compared to a threshold number.
